(19) United States
(12) Patent Application Publication
(10) Pub. No.: US 2017/0111724 A1
(43) Pub. Date: Apr. 20, 2017

(54) Dual Purpose Power and Headset Interface System

(71) Applicant: Christopher Mathew Toner, Germantown, MD (US)

(72) Inventor: Christopher Mathew Toner, Germantown, MD (US)

(21) Appl. No.: 15/291,022

(22) Filed: Oct. 11, 2016

Related U.S. Application Data
(60) Provisional application No. 62/240,299, filed on Oct. 12, 2015.

(51) Int. Cl. H04R 1/10; H01R 24/60

(52) U.S. Cl. CPC H04R 1/1033; H01R 24/60; H04R 2420/09; H01R 2107/00

(57) ABSTRACT

A dual purpose power and headset interface system including a headset, a cable coupled to the headset and a docking unit and a docking unit. The docking unit is connected to a detachable integrated power and audio cable and operates to transfer power or audio from the integrated power and audio cable to the headset or to dock the integrated power and audio cable until subsequent use. The system allows a user to carry one assembly providing integrated power and audio functions without having to carry two separate devices, such as, ear buds and a power cord.

### CROSS-REFERENCE TO RELATED APPLICATION

This application claims the benefit of priority of U.S. Provisional Application No. 62/240,299 filed on Oct. 12, 2015, the disclosure of which is incorporated herein by reference in its entirety.

### FIELD OF THE INVENTION

Embodiments described herein generally relate to the field of power cords and headsets, and more specifically to a dual purpose power and headset interface system.

### BACKGROUND OF THE INVENTION

In current practice, a user of a smartphone needs to carry two separate wired devices, one for power/charging/data sync and one for audio headsets. Hence, users, such as, travelers, sport participants, office workers, students and almost any other users of smartphone's, tablets, computer devices and other audio players, invariably share a common challenge of carrying and remembering to carry both audio headsets and a charging cable when mobile. Quite often, a user forgets one or the other. Thus, a need exists to provide a more efficient way of providing power and audio to user with minimal hardware.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary illustration of the dual purpose power and headset interface system according to an embodiment of the present disclosure.

FIG. 2 shows an exemplary illustration of the dual purpose power and headset interface system connected to an integrated power and audio cable according to an embodiment of the present disclosure.

FIG. 3 shows an exemplary illustration of the dual purpose power and headset interface system connected to a smartphone according to an embodiment of the present disclosure.

FIG. 4 shows an exemplary illustration of the dual purpose power and headset interface system, integrated power and audio cable and optional audio adapter connected to form an audio path according to an embodiment of the present disclosure.

FIGS. 5-6 show exemplary illustrations of the dual purpose power and headset interface system including a wireless audio stream according to an embodiment of the present disclosure.

FIGS. 7-8 show exemplary illustrations of the dual purpose power and headset interface system used with a smartphone and/or a tablet computer, with or without wireless audio capability.

FIG. 9 shows an exemplary illustration of the core schematic and wiring of a standard Apple Lightning™ connector/cable to USB connector.

FIG. 10 shows an exemplary illustration of a schematic and wiring used to allow the audio system to use a common Apple Lightning™ connector/cable as the audio transfer medium.

FIG. 11 shows an exemplary illustration of the core schematic and wiring of a standard Mini/Micro USB connector/cable to USB connector.

FIG. 12 shows an exemplary illustration of the schematic and wiring used to allow the audio system to use a common Mini/Micro USB connector/cable to USB connector, as the audio transfer medium.

### SUMMARY OF THE INVENTION

Exemplary embodiments disclosed herein describe a dual purpose power and headset interface system including a headset, a docking unit, and a cable connected to the headset and docking unit. The docking unit configured to connect to a detachable integrated power and audio cable. The docking unit operates to transfer power or audio from the detachable integrated power and audio cable to the headset and to dock the detachable integrated power and audio cable for subsequent use.

In some exemplary embodiments, the dual purpose power and headset interface system may include an audio adapter. The audio adapter is adapted to connect to the detachable integrated power and audio cable, and is also adapted to connect to at least one or more from the group comprising a smart phone, tablet, personal computer, audio player, desktop, or computer device.

In some exemplary embodiments, the docking unit is adapted to engage in a digital audio exchange with a smartphone through a Apple Lightening™ connector/cable or USB to Micro/Mini USB cables which is connected directly to the smartphone.

In some exemplary embodiments, the detachable integrated power and audio cable is connected directly to the docking unit at one end and is connected directly to at least one from the group comprising a smart phone, tablet, personal computer, audio player, desktop, or computer device at the other end.

In some exemplary embodiments, the docking unit includes a casing embedded with a connector port and the integrated power and audio cable plugs into the connector port.

In some exemplary embodiments, the connector port is a USB connector port.

In some exemplary embodiments, the audio adapter includes a connector port, and the connector port may include a Apple Lightning™ connector port.

In some exemplary embodiments, the headset includes at least one from the group comprising a wireless listening device and a wired listening device.

In some exemplary embodiments, the dual purpose power and headset interface system includes a mechanical connection interface molded into the docking unit to attach the docking unit to clothing as a wearable device.

### DETAILED DESCRIPTION

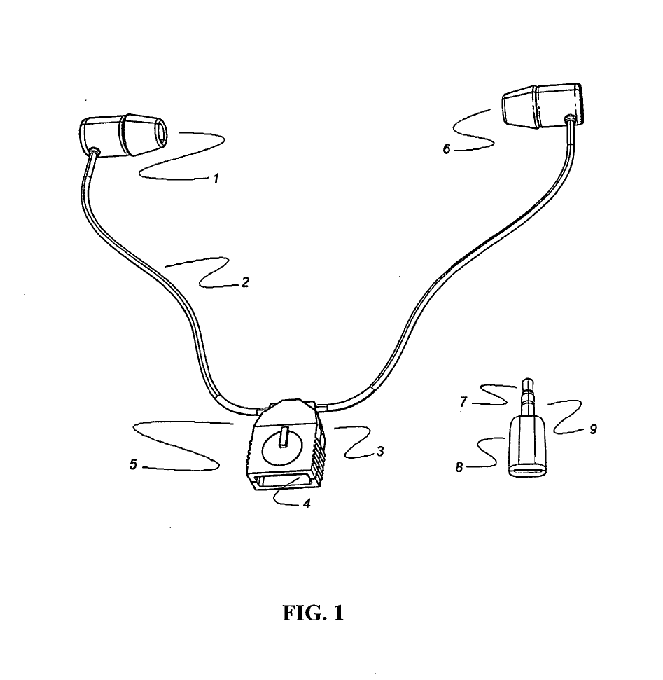

The present disclosure describes a dual purpose power and headset interface system 5 (“Power Heads”), which allows a user to carry one assembly providing integrated power and audio functions without having to carry two separate devices, such as, ear buds and a power cord. As illustrated in FIG. 1, the Power Heads includes ear buds 1 and 6 (i.e., the headset); the ear bud wire 2; a docking unit, which includes Power Heads casework 3 (i.e., casing/housing) and USB port 4; and optional audio adapter 9, which includes audio plug 7, and audio adapter housing 8.

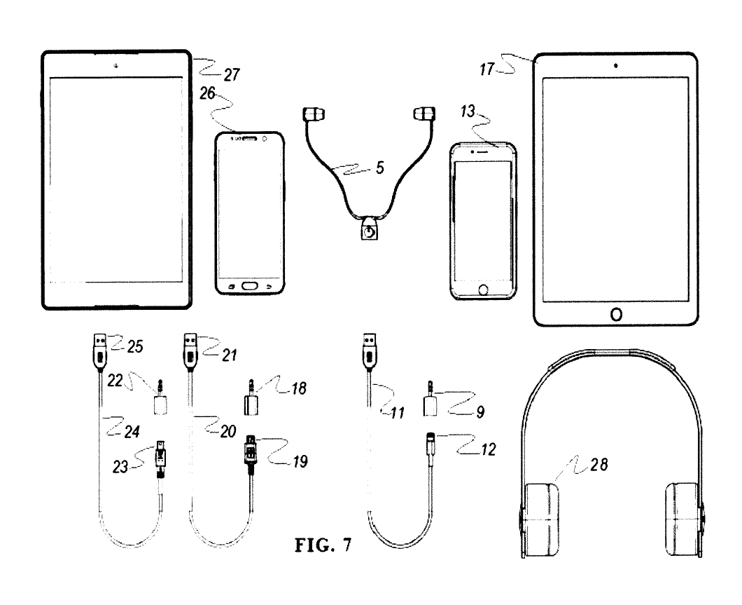

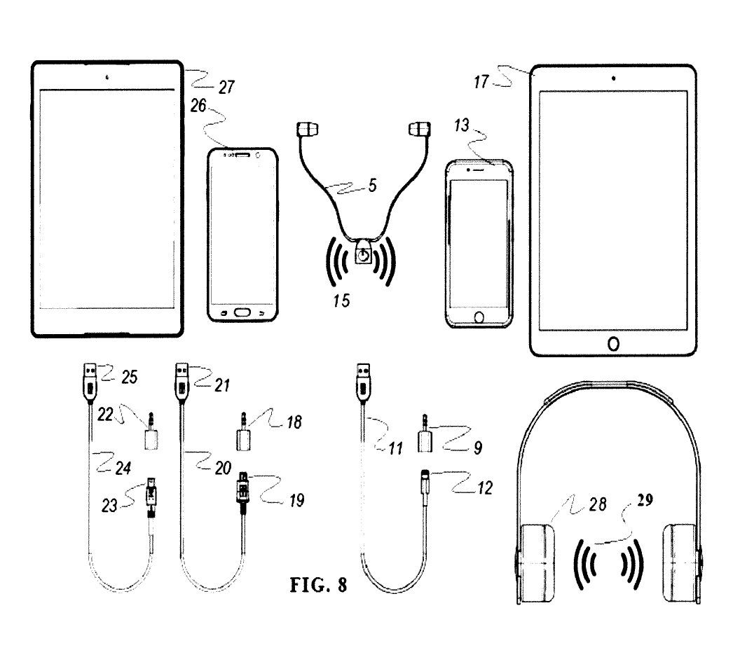

The terms “ear bud”, “headphones”, “in-ear headphones” or “on-ear and over-ear headphones”, or “headset” broadly includes all types of head mounted audio listening devices, wired or wireless, including but not limited to traditional mobile and cell phones, smartphones, tablets, computers, music players, stereo equipment and wearable computers/devices (see FIGS. 7-8, References 28-29).

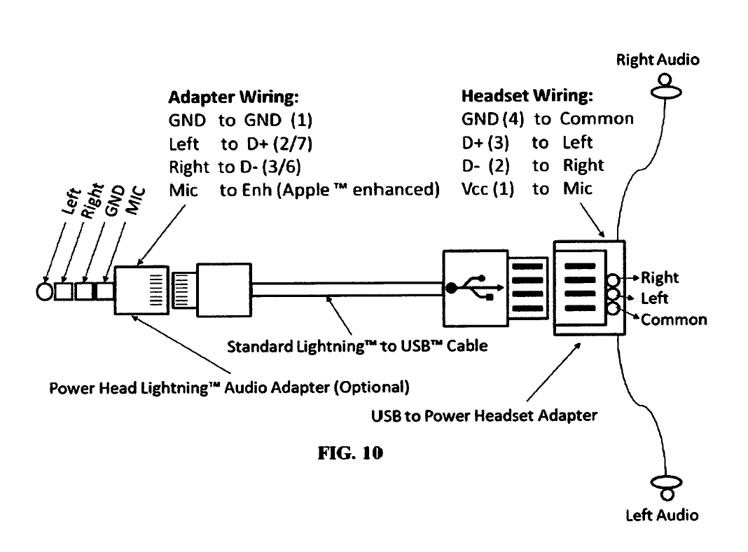

The docking unit is a mechanical and electrical structure that combines power cord docking capability (i.e., plug-in feature for allowing an integrated power and audio cord to dock thereto or for charging the headset) with audio transfer capability (i.e., transferring audio from the integrated power and audio cable to the headset). The docking unit includes the prescribed wiring and signal conversion to make the ear buds left 6 and right 1 work with the optional audio adapter 9 (see FIG. 10).

The integrated power and audio cable is a single cable that can transfer audio, data and power through its medium. When the integrated power and audio cable plugs into the docking unit, the cable is docked at the docking unit until the cable is needed to provide power, data or audio. This feature allows the user to carry a single cable for power and audio transmission. Moreover, this feature allows the user to store the cable in the Power Heads assembly for subsequent use with another device. The user can detach the integrated power and audio cable to use with another device.

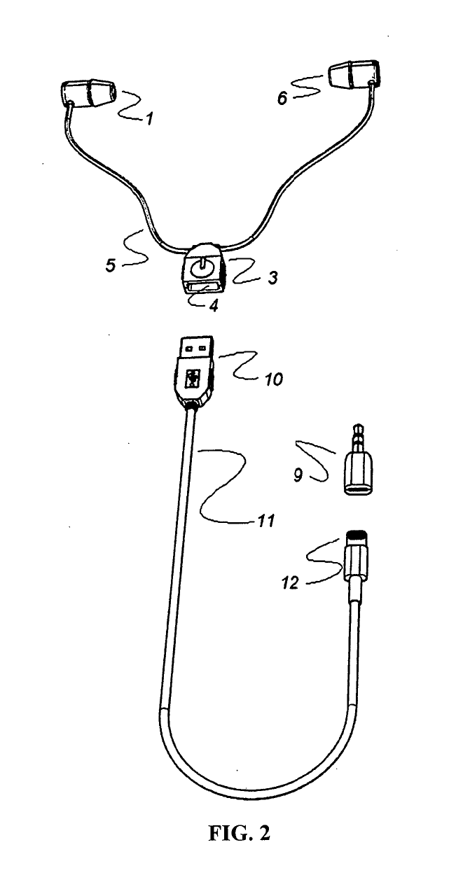

As shown in FIG. 2, the integrated power and audio cable 11, includes a USB connector 10 which plugs into USB port 4 for docking/charging/transferring audio, and which may be un-plugged (i.e., detached) from the USB port so that the cable 11 can be used with other devices. Moreover, the integrated power and audio cable may include, for example, a Apple Lightning™ connector/cable, a USB to Mini/Micro USB cable, or any other power, battery charging and/or data I/O cables that can also transmit audio. The Apple Lightning™ cable includes a Lightning™ connector 12, which may be plugged into optional audio adapter 9 or directly to a compatible smart phone.

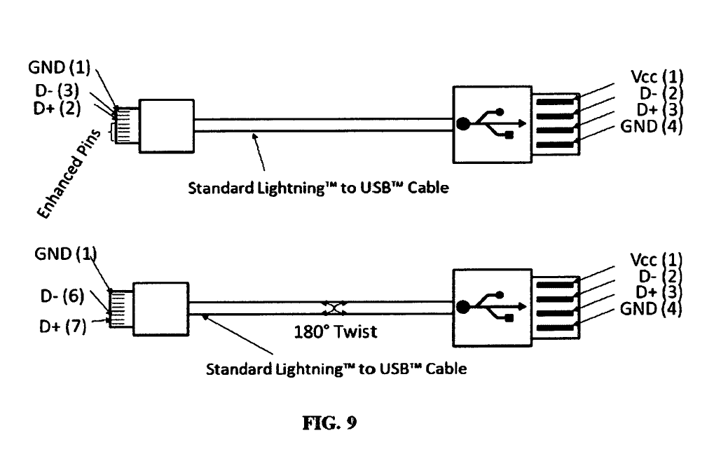

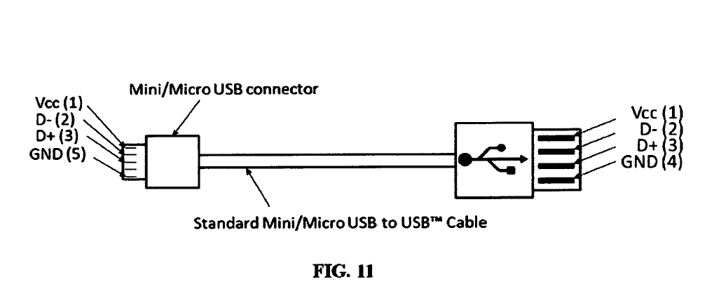

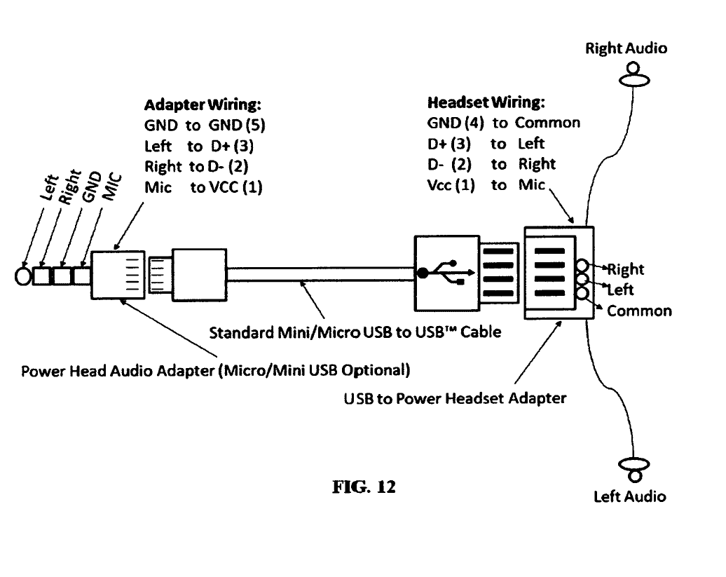

The optional audio adapter 9 includes audio plug 7 and housing 8, which contains the prescribed wiring and signal conversion (see FIG. 10). The optional audio adapter 9 uses the integrated power and audio cable as the wire medium to transfer sound to the headset. For example, as shown in FIGS. 9-10, the Apple Lightning™ cable has three conductors, referred to as D−, D+ and GND, which can be repurposed for audio transmission to Left, Right and Common, thus enabling the standard Apple Lightning™ connector/cable to become the wire for the headsets and also be separated in modular form to still be a power, charge and data cable as commonly used. Moreover, the standard USB to Micro/Mini to USB cable has a similar architecture as shown in FIGS. 11-12, which allows the cable to be used as a power and audio cable.

In practice there are no required modifications to the Apple® interconnectivity, software, electrical connections or other special devices to make the combination of power and audio for use of the standard Apple Lightning™ connector or cable used for power, charging and data transfer/syncing of Apple® products, other than as described in the disclosure. Moreover, there are no required modifications to the interconnectivity, software, electrical connections or other special devices for systems using the standard USB to Micro/Mini to USB cable to make the combination of power and audio possible for the standard USB to Micro/Mini to USB cable.

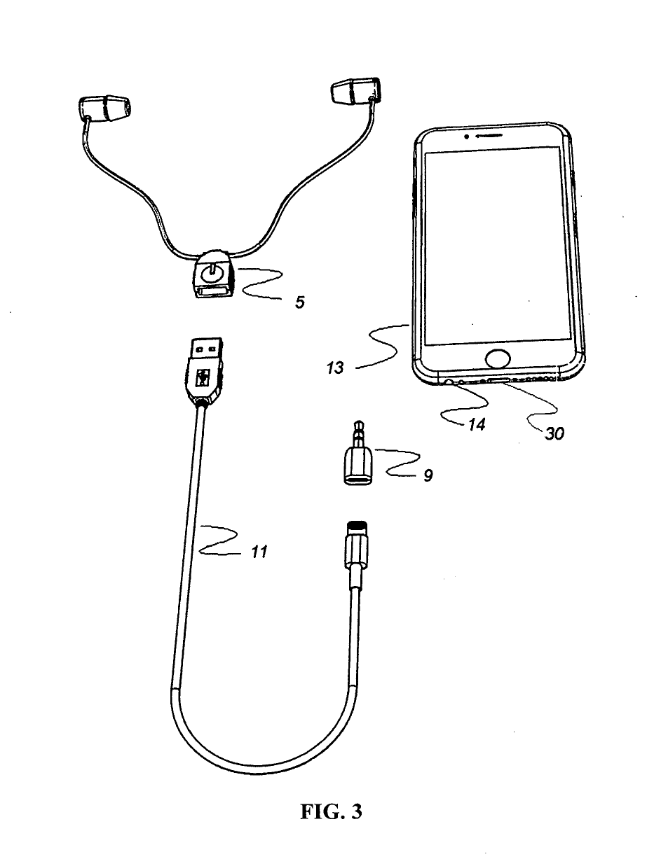

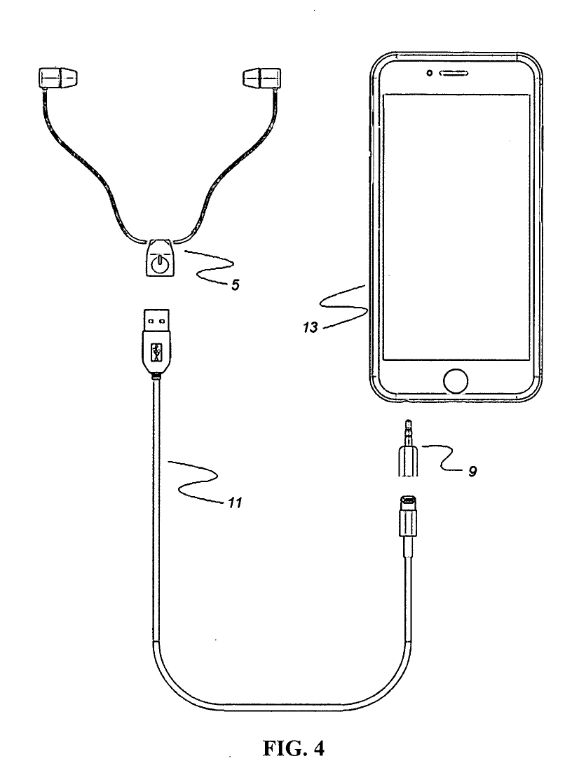

As shown in FIGS. 3-6, the audio adapter 9 may be connected to a device which provides power, data, and audio, such as, for example, Apple iPhone™ 13 or Apple iPad™ 17, when the integrated power and audio cable includes Apple Lightning™ connector/cable 11. The Apple iPhone™ 13 may include an audio out connector port 14, for connection with the optional audio adapter 9 and the Apple iPad™ 17 may include an audio I/O port(s) 16 for connection with the audio adapter. Moreover, the device may adapt to a port for direct connection with associated Apple Lightning™ connector 30 with the integrated power and audio, not requiring the optional audio adapter 9.

As shown in FIGS. 7-8, the audio adapter 9, in an alternative embodiment, may be connected to a typical Droid, Microsoft or other family of smartphones 26 and Droid, Microsoft or other family of tablet computers 27, along with the different associated Power Head adapters Micro USB 18 & Mini USB 22, when the integrated power and audio cable includes a Micro USB connector/cable to USB 20 or a Mini USB connector/cable to USB 24. The Micro USB connector/cable to USB 20 includes Micro USB connector 19, which connects to audio adapter 9 and USB connector 21 which connects to USB port 4. The Mini USB connector/cable to USB 24 includes Mini USB connector 23 which connects to an optional audio adapter 9 and USB connector 25 which connects to USB port 4.

While embodiments of the disclosure describe the Power Heads receiving audio from the audio adapter via the integrated power and audio cable, the Power Heads may receive audio or power directly from the integrated power and audio cable without the use of the audio adapter. In this scenario, the integrated power and audio cable may connect directly to the source of power/audio, such as, for example, a smartphone (e.g. Apple Lightening™ connector), tablet, pc, laptop or any other audio delivery device.

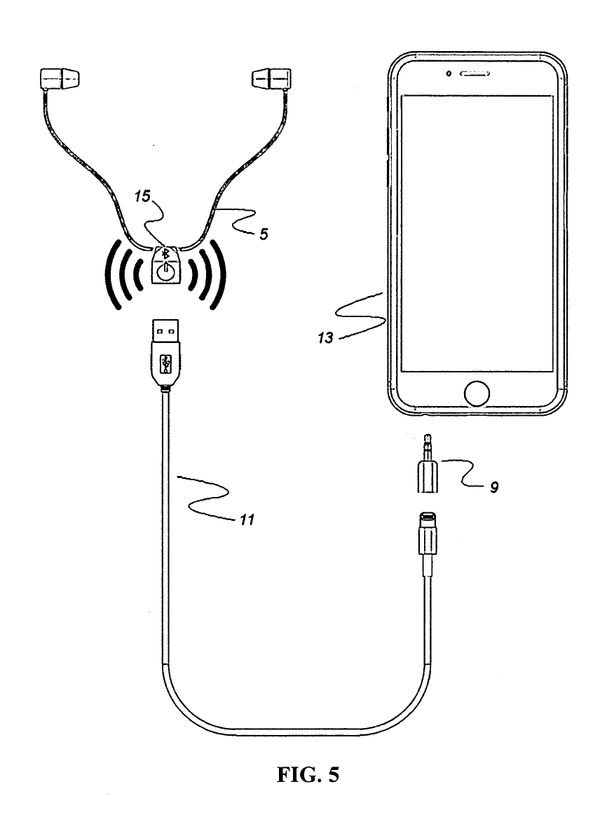

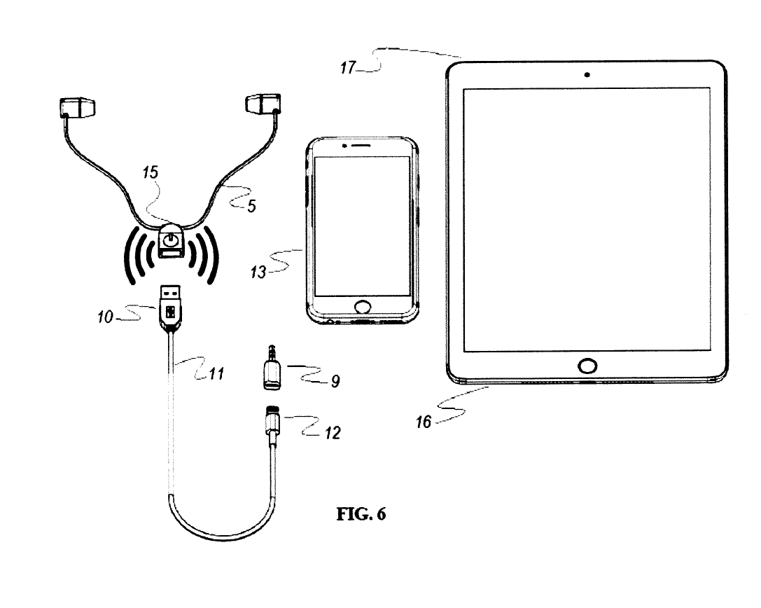

The Power Heads 5 may also operate from a battery source, with a wireless audio stream (e.g. Bluetooth or other low power wireless) communications protocol (i.e., wireless Power Heads 15) (see FIGS. 5-6). The Power Heads system can still be utilized to recharge the battery source, in this embodiment. The Power Heads can be connected directly to a device utilizing the Apple Lightening™ connector/cable (e.g., a smartphone), and charge a wireless headset version of the Power Heads or transfer audio as a digital stream for lossless and noise filtered audio transmission.

In an alternative exemplary embodiment, the Power Heads may include a unique mechanical connection interface using either magnets, fasteners or an interconnection profile molded into the Power Heads casework to accommodate the fixation to clothing as a wearable device.

In another exemplary embodiment of the present disclosure, a power, charging and data cable is packaged with a secondary audio cable; thereby allowing the user to carry one assembly versus multiple dedicated elements to accomplish equivalent functionality. In this embodiment, the common cord would have both the USB end and the Apple Lightening™ connector end be packaged with a molded audio cable running alongside the power cable to provide dual purpose in one modular assembly.

Further, the Power Heads can utilize traditional and future aspects of the Apple Lightening™ connector/cable, USB to Micro/Mini to USB connector/cable and audio headsets (earbuds, earphones, in-ear, over-ear, wireless and headsets) combined as a multipurpose assembly, combining functionality and usefulness compared to the current functionality and usefulness.

Moreover, further functionality and use of Power Heads can be found by utilizing other capabilities of the Apple Lightening™ connector/cable. This further functionality includes for example, power headphones, wireless headphones, noise cancelling/powered headphones, digital audio transfer and heads up displays.

When the Power Heads assembly uses the USB to Micro/Mini USB interface cable, further functionality can be realized without modifications of the cables or devices (smartphones/tablets). For example, the Power Heads may enable full duplex audio out (stereo and derivatives) and audio in (microphone) functionality, audio volume adjust, wireless headphone charging, noise detection and cancellation and play/stop/rewind/fast forward control logic. Moreover, future functionality around both audio capabilities and extensions of the dual/multipurpose modularity of the Power Heads, can be made beyond the noted functionality in this disclosure, such as, for example, Heads Up Displays and Wearable Displays.

The Power Heads architecture allows the docking unit to engage in a digital audio exchange with a smartphone through a Apple Lightening™ connector/cable or USB to Micro/Mini USB cables which is connected directly to the smartphone. This allows for audio as a digital stream for lossless and noise filtered audio transmission.

The Power Heads, when combined with an audio output device such as speakers, Bluetooth headset or future wireless headsets, create a new mode of computer and user experience, reducing the number of hands fingers and interactions required for interfacing with your mobile and tablet computer environments, as related to audio I/O.

The Power Heads provides a new audio interface to smartphones and in particular the Apple Lightening™ connector/cable and USB to Mini/Micro USB cables, to enhance the functionality and add the ability for powered headsets, including noise cancelling capability and powered microphone for voice calling.

The disclosed embodiments are not inclusive and many other modifications and variations will be apparent to someone of ordinary skill in the art with construction skills in the related arts. Together the descriptions and accompanying illustrations seek to provide an explanation of the basic principles of the embodiment and its application. It is therefore intended that the specification and embodiments be considered as exemplary only. The true scope of the embodiments of the invention should not be so limited since other modifications will become apparent to the skilled practitioner upon a study of the drawings, specification, and following claims.

What is claimed is:

1. A dual purpose power and headset interface system, the system comprising:
a headset;
a cable coupled to the headset and a docking unit; and
a docking unit configured to connect to a detachable integrated power and audio cable, wherein the docking unit operates to transfer power or audio from the detachable integrated power and audio cable to the headset and to dock the detachable integrated power and audio cable for subsequent use.

2. The system of claim 1, further comprising an audio adapter configured to connect to the detachable integrated power and audio cable.

3. The system of claim 1, wherein the docking unit is adapted to engage in a digital audio exchange with a smartphone through a Apple Lightening™ connector/cable or USB to Micro/Mini USB cables which is connected directly to the smartphone.

4. The system of claim 1, wherein the detachable integrated power and audio cable is connected directly to the docking unit at one end and is connected directly to at least one from the group comprising a smart phone, tablet, personal computer, audio player, desktop, or computer device at the other end.

5. The system of claim 2, wherein the audio adapter is configured to connect to at least one or more from the group comprising a smart phone, tablet, personal computer, audio player, desktop, or computer device.

6. The system of claim 1, wherein the docking unit includes a casing embedded with a connector port, wherein the integrated power and audio cable plugs directly into the connector port.

7. The system of claim 1, wherein the headset includes at least one from the group comprising a wireless listening device and a wired listening device.

8. The system of claim 1, further comprising a mechanical connection interface molded into the docking unit to attach the docking unit to clothing as a wearable device.

9. The system of claim 6, wherein the connector port is a USB connector port.

10. The system of claim 2, wherein the audio adapter includes a connector port.

11. The system of claim 10, wherein the connector port is a Apple Lightning™ connector port.
